(19) United States
(12) Patent Application Publication
(10) Pub. No.: US 2014/0293753 A1
(43) Pub. Date: Oct. 2, 2014

(54) SMARTPHONE ACTIVATED VEHICLE ENTRY DEVICE

(71) Applicant: David Pearson, Romeo, MI (US)

(72) Inventor: David Pearson, Romeo, MI (US)

(21) Appl. No.: 14/243,544

(22) Filed: Apr. 2, 2014

Related U.S. Application Data
(60) Provisional application No. 61/807,410, filed on Apr. 2, 2013.

(51) Int. Cl. G08C 23/02

(52) U.S. Cl. CPC G08C 23/02
USPC 367/197

(57) ABSTRACT

A smartphone or other portable electronic device is operative to unlock and lock a vehicle without the use of the cellular or Wi-Fi network or any additional hardware added to the portable unit. The system, which is configured for use with a vehicle having an existing receiver to receive remote keyless entry (RKE) codes, includes a vehicle-mounted unit with a microphone to receive an acoustic signal from a smartphone or other portable electronic device programmed to generate a modulated, encoded acoustic vehicle entry command. Circuitry in the vehicle-mounted unit demodulates and decodes the vehicle entry command, and a transmitter in the vehicle-mounted unit transmits the demodulated and decoded command to the existing RKE receiver in the vehicle to execute the command, which may be a door LOCK or UNLOCK command. A passive RKE embodiment is also disclosed.

### REFERENCE TO RELATED APPLICATION

This application claims priority from U.S. Provisional Patent Application Ser. No. 61/807,410, filed Apr. 2, 2013, the entire content of which is incorporated herein by reference.

### FIELD OF THE INVENTION

This invention relates generally to portable electronic devices and, in particular, to the use of a smartphone or other portable electronic device to operate a vehicle entry device.

### BACKGROUND OF THE INVENTION

As cell phones have evolved into smartphones, the devices have taken on a wide range of applications and uses. One area where smartphones are deficient is in the control of other electronic devices. For example, while a smartphone may be used as a remote control transmitter, an external add-on device must be provided to transmit the requisite infrared (IR) signals. For most smartphone universal remotes, such devices are provided in the form of a “dongle” that connects to the phone. The main drawback of this approach is that most dongle-based IR emitters are proprietary to a particular app. Some apps forgo dongles, using external boxes for control instead. The phone communicates with the box via Bluetooth or other wireless protocols as available. While this arrangement does not require the user to attach a gizmo to their phone, the downside is the requirement of a specific hardware box.

It would therefore be advantageous to enable a smartphone to control a different device without the use of external hardware, relying instead on the available outputs of the smartphone without modification.

### SUMMARY OF THE INVENTION

This invention enables a smartphone or other portable electronic device to unlock and lock a vehicle (or perform other functions) without the use of the cellular or Wi-Fi network or any hardware added to a smartphone or other portable electronic device. The system, which is configured for use with a vehicle having an existing receiver to receive remote keyless entry (RKE) codes, includes a vehicle-mounted unit with a microphone to receive an acoustic signal from a smartphone or other portable electronic device programmed to generate a modulated, encoded acoustic vehicle entry command. Circuitry in the vehicle-mounted unit demodulates and decodes the vehicle entry command, and a transmitter in the vehicle-mounted unit transmits the demodulated and decoded command to the existing RKE receiver in the vehicle to execute the command, which may be a door LOCK or UNLOCK command.

The system may further include a smartphone or other portable electronic device including an application or “app” enabling the smartphone or other portable electronic device to generate a modulated, encoded acoustic vehicle entry command for a particular vehicle.

In a passive entry embodiment, the vehicle-mounted unit is operative to generate an encoded acoustic signal. The smartphone or other portable electronic device includes a microphone and is programmed to decode the acoustic signal from the vehicle-mounted unit and automatically generate the modulated, encoded acoustic vehicle entry command in response thereto. The system in this case may further include a smartphone or other portable electronic device including an application or “app” enabling the smartphone or other portable electronic device to: (a) decode the acoustic signal from the vehicle-mounted unit and automatically generate the modulated, encoded acoustic vehicle entry command for that vehicle in response thereto as part of a passive RKE system, and (b) generate a modulated, encoded acoustic vehicle entry command for that vehicle.

The modulated, encoded acoustic vehicle entry command may include a vehicle device serial number, a rolling code, the vehicle command, and error checking data. The modulated, encoded acoustic vehicle entry command may be encrypted, in which case the circuitry in the vehicle-mounted unit is further operative to decrypt the vehicle entry command received from the smartphone or other portable electronic device. The vehicle-mounted unit may be battery operated, and the acoustic signal may be sub-sonic, audible or ultra-sonic.

### BRIEF DESCRIPTION OF THE DRAWINGS

FIG. 1 is a simplified block diagram illustrating a basic system according to the invention; and

FIG. 2 shows a passive entry system using a smartphone or equivalent used as a personal located transponder in a passive entry system.

### DETAILED DESCRIPTION OF THE INVENTION

This invention enables a smartphone or other portable electronic device to unlock and lock a vehicle (or perform other functions) without the use of the cellular or Wi-Fi network or any hardware added to a smartphone or other portable electronic device. An “app” on the smartphone, with either a soft keypad or voice activated application, is used to transmit a modulated acoustic serial data stream via the smartphone's speaker. The data stream, being acoustic, (sub-sonic, audible, or ultra-sonic) is either Amplitude Modulated (AM) or Frequency Shift Keyed (FSK) or other type of modulation schemes. The transmitted data stream may be encrypted for security and error checked using a CRC or Checksum. An AES or rolling code encryption may also be used to encrypt the data stream.

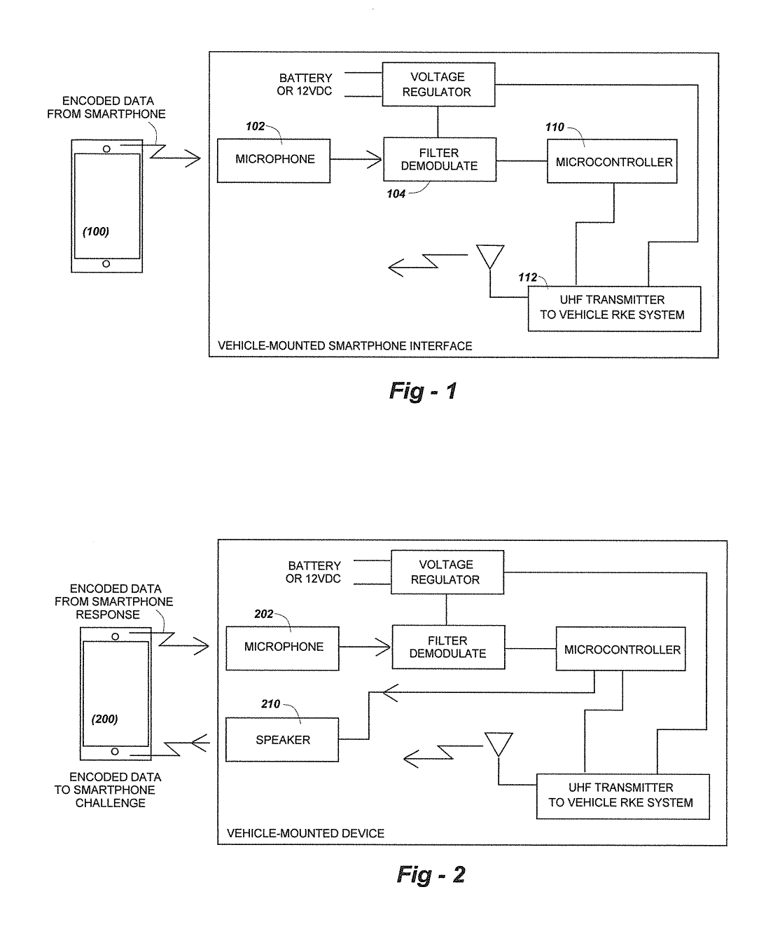

FIG. 1 is a simplified block diagram illustrating vehicle-mounted unit according to the invention. This hardware is a battery or vehicle-powered device that includes a microphone 102 feeding an audio bandpass filter and detector circuit in demodulator 104. The detected signal is fed into a microcontroller 110 programmed to decrypt the data stream and recover the command from the smartphone (or other portable sound-generating device) 100. Together with or in place of battery operation, other power sources may be used including, solar, vibrational energy harvesting, RF power stealing from power lines or radio stations.

Each data packet from the smartphone to the vehicle mounted device preferably includes the following encoded data: vehicle device serial number, rolling code, command, and error checking data. The microcontroller in the vehicle mounted device drives a UHF transmitter 112 that transmits the RKE commands (i.e., LOCK, UNLOCK) to the vehicle when instructed by the smartphone acoustic link. The vehicle-mounted device contains the protocol to interface to the RKE system inside the vehicle and is paired with the vehicle. The vehicle mounted device may be placed on the door and combined with the current Wireless keypad, or it could be mounted at hidden place on the vehicle within audible range. If the vehicle-mounted device is factory supplied, it would be loaded with the appropriate RKE codes. If provided as an after-market device, the codes may be entered by a dealer or a customer assuming appropriate security safeguards.

### PASSIVE ENTRY SYSTEM EMBODIMENT

FIG. 2 shows a passive entry system using a smartphone or equivalent used as a personal located transponder in a passive entry system. The smartphone or other device 200 in this case would run an app that would have the smartphone constantly listening via its microphone 202 for an audio data stream from the vehicle mounted device. When the app detects a valid audio data stream from the vehicle device, the app would then command the smartphone to transmit an audio data steam response to the vehicle. The vehicle-mounted device would receive audio signals from the smartphone using an audio transducer and transmit to the smartphone using an audio transducer such as speaker 210.

When the app detects a valid audio data stream from the vehicle device, the app would then command the smartphone to transmit a Bluetooth signal to a paired factory Bluetooth receiver in the vehicle that responds to locking commands. (Unlocking via Bluetooth is now a feature on some vehicles, this device would convert the smartphone to a passive entry device) Together with or in place of battery operation, other power sources may be used to power the vehicle-mounted device including, solar, vibrational energy harvesting, RF power stealing from power lines or radio stations.

An audio data stream transmission from the vehicle-mounted device may be initiated by various means, including pressing a push button on the device, capacitive proximity sensing, or other methods. The vehicle-mounted device would transmit via audio data stream to the smartphone and receive the response from the smartphone. Once the challenge/response sequence is verified, the vehicle-mounted device would then transmit an RF signal conforming to the vehicles RKE protocol to open or close the door locks. Vehicle automatic locking could be implemented using a periodic challenge/response initiated by the vehicle mounted device. This, however, would require a vehicle-powered device.

1. A vehicle entry system for a vehicle with an existing receiver to receive remote keyless entry (RKE) codes, the system comprising:
a vehicle-mounted unit including a microphone configured to receive an acoustic signal from a smartphone or other portable electronic device programmed to generate a modulated, encoded acoustic vehicle entry command;
circuitry in the vehicle-mounted unit for demodulating and decoding the vehicle entry command; and
a transmitter in the vehicle-mounted unit for transmitting the demodulated and decoded command to the existing RKE receiver in the vehicle to execute the command.

2. The vehicle entry system of claim 1, wherein the command is a door LOCK or UNLOCK command.

3. The vehicle entry system of claim 1, wherein:
the vehicle-mounted unit is operative to generate an encoded acoustic signal; and
the smartphone or other portable electronic device includes a microphone and is programmed to decode the acoustic signal from the vehicle-mounted unit and automatically generate the modulated, encoded acoustic vehicle entry command in response thereto as part of a passive RKE system.

4. The vehicle entry system of claim 1, further including a smartphone or other portable electronic device including an application or “app” enabling the smartphone or other portable electronic device to generate a modulated, encoded acoustic vehicle entry command for a particular vehicle.

5. The vehicle entry system of claim 3, further including a smartphone or other portable electronic device including an application or “app” enabling the smartphone or other portable electronic device to:
(a) decode the acoustic signal from the vehicle-mounted unit and automatically generate the modulated, encoded acoustic vehicle entry command for that vehicle in response thereto as part of a passive RKE system, and
(b) generate a modulated, encoded acoustic vehicle entry command for that vehicle.

6. The vehicle entry system of claim 1, wherein the modulated, encoded acoustic vehicle entry command is encrypted and the circuitry in the vehicle-mounted unit is further operative to decrypt the vehicle entry command.

7. The vehicle entry system of claim 1, wherein the modulated, encoded acoustic vehicle entry command further includes a vehicle device serial number.

8. The vehicle entry system of claim 1, wherein the modulated, encoded acoustic vehicle entry command further includes a rolling code.

9. The vehicle entry system of claim 1, wherein the modulated, encoded acoustic vehicle entry command further includes error-checking data.

10. The vehicle entry system of claim 1, wherein the vehicle-mounted unit is battery operated.

11. The vehicle entry system of claim 1, wherein acoustic signal is sub-sonic.

12. The vehicle entry system of claim 1, wherein acoustic signal is audible.

13. The vehicle entry system of claim 1, wherein acoustic signal is ultra-sonic.
